(19) United States
(12) Patent Application Publication
(10) Pub. No.: US 2026/0203804 A1
(43) Pub. Date: Jul. 16, 2026

(54) INFORMATION PROVIDING DEVICE, INFORMATION PROVIDING METHOD, AND RECORDING MEDIUM

(71) Applicant: NEC Corporation, Tokyo (JP)

(72) Inventors: Shinji FUNAI, Tokyo (JP); Takahiro MATSUI, Tokyo (JP); Takashi SHIMIZU, Tokyo (JP); Yoshiya UOTANI, Tokyo (JP)

(73) Assignee: NEC Corporation, Tokyo (JP)

(21) Appl. No.: 19/137,699

(22) PCT Filed: Dec. 20, 2022
(86) PCT No.: PCT/JP2022/046760

§ 371 Date: Jun. 11, 2025

(51) Int. Cl. G06Q 30/0601

(52) U.S. Cl. CPC G06Q 30/0631

(57) ABSTRACT

The present invention provides an information providing device comprising: an acquiring means that acquires product information about products in each of product-containing means being used by customers in a store; a determining means that determines a recommended product to recommend to customers in the store on the basis of the product information; and an outputting means that outputs information about the determined recommended product to an output device in the store.

### TECHNICAL FIELD

The present disclosure relates to an information providing device, an information providing method, and a recording medium.

### BACKGROUND ART

There is a system that provides a customer with product information of interest. For example, PTL 1 discloses that in a real store, a product whose holding is started by a customer who is shopping is acquired as purchase candidate information, and a recommended product to be recommended to the customer is selected based on the purchase candidate information.

### CITATION LIST

### Patent Literature

PTL 1: WO 2018/230355 A1

### SUMMARY OF INVENTION

### Technical Problem

In the technique described in PTL 1, a recommended product is selected based on product information that a customer has started holding. In this case, the recommended product cannot be selected while the customer does not hold the product. In a case where the number of products held by the customer is small, the products that can be selected as the recommended products are also limited.

An example of an object of the present disclosure is to provide an information providing device capable of providing product information that a customer is likely to purchase regardless of a customer's shopping status.

### Solution to Problem

An information providing device according to an aspect of the present disclosure includes: an acquiring means that acquires product information in each of product-containing means being used by customers in a store; a determining means that determines a recommended product to recommend to customers in the store based on the product information; and an outputting means that outputs information of the determined recommended product to an output device in the store.

An information providing method according to an aspect of the present disclosure causes a computer to execute: acquiring product information in each of product-containing means being used by customers in a store; determining a recommended product to recommend to customers in the store based on the product information; and outputting information of the determined recommended product to an output device in the store.

A recording medium according to one aspect of the present disclosure has stored therein a program causing a computer to execute: acquiring product information in each of product-containing means being used by customers in a store; determining a recommended product to recommend to customers in the store based on the product information; and outputting information of the determined recommended product to an output device in the store.

### Advantageous Effects of Invention

According to the present disclosure, it is possible to provide an information providing device capable of providing product information that a customer is likely to purchase regardless of a situation of customer's shopping.

### BRIEF DESCRIPTION OF DRAWINGS

FIG. 1 is a block diagram illustrating a configuration of an information providing device according to a first example embodiment.

FIG. 2 is a diagram illustrating a hardware configuration in which the information providing device according to the first example embodiment is implemented by a computer device and its peripheral device.

FIG. 3 is an example of a screen of information of a recommended product output by an outputting unit in the first example embodiment.

FIG. 4 is a flowchart illustrating an operation of the information providing device according to the first example embodiment.

FIG. 5 is a block diagram illustrating a configuration example of an information providing device according to a modification of the first example embodiment.

FIG. 6 is a diagram for explaining a method of determining a recommended product by a determining unit in a modification of the first example embodiment.

FIG. 7 is a flowchart illustrating an operation of the information providing device in a modification of the first example embodiment.

FIG. 8 is a block diagram illustrating a configuration of an information providing device according to a second example embodiment.

FIG. 9 is a flowchart illustrating an operation of the information providing device according to the second example embodiment.

### EXAMPLE EMBODIMENT

Hereinafter, example embodiments of an information providing device, an information providing method, and a non-transitory recording medium recording a program according to the present disclosure will be described in detail with reference to the drawings. The present example embodiment does not limit the disclosed technology.

In the present example embodiment, information of the recommended product is output to the output device in the store for the customer who is shopping. The store is, for example, a retail store such as a supermarket and a home center. The information of the recommended product in the present example embodiment is sales information of a specific product to be recommended to a customer, and includes a feature, a price, a display place, inventory information, and the like of the product.

Examples of the output device include a customer terminal such as a tablet terminal provided in a shopping cart or a customer's own smartphone terminal, a signage, and a speaker. The output device outputs information of the recommended product as a voice, a moving image, or a still image. An installation place of the output device is not particularly limited. For example, the output device may be installed near an entrance of a store, may be installed on a product shelf, a door of the product shelf, a window of the store, a ceiling, or the like, or may be installed on a floor of the store.

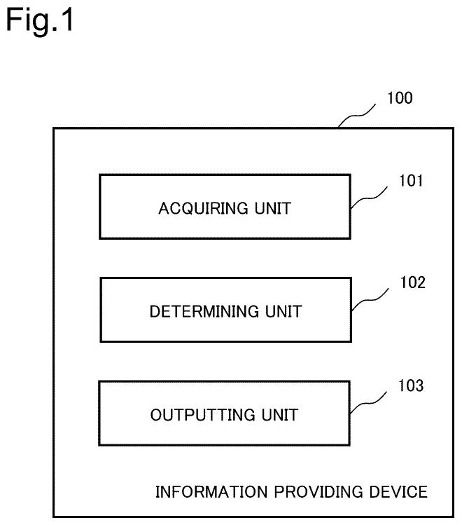

FIG. 1 is a block diagram illustrating a configuration of an information providing device 100 according to a first example embodiment. Referring to FIG. 1, the information providing device 100 includes an acquiring unit 101, a determining unit 102, and an outputting unit 103.

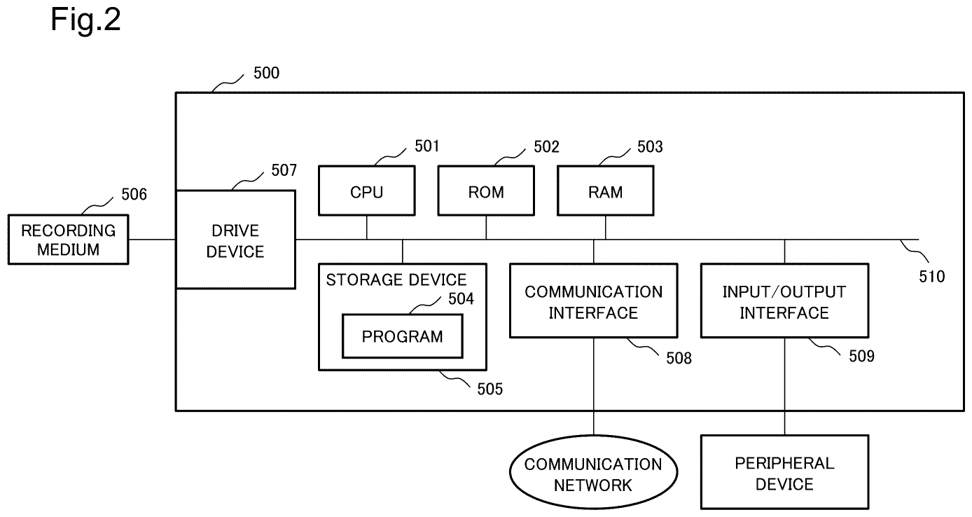

FIG. 2 is a diagram illustrating an example of a hardware configuration in which the information providing device 100 according to the first example embodiment of the present disclosure is achieved by a computer device 500 including a processor. As illustrated in FIG. 2, the information providing device 100 includes a central processing unit (CPU) 501, a memory such as a read only memory (ROM) 502 and a random access memory (RAM) 503, a storage device 505 such as a hard disk that stores a program 504, a communication interface 508 for network connection, and an input/output interface 509 that inputs and outputs data. In the first example embodiment, the information providing device 100 is connected to each component via a bus 510. The information providing device 100 according to the first example embodiment illustrated in FIG. 1 can be configured by cloud computing or the like.

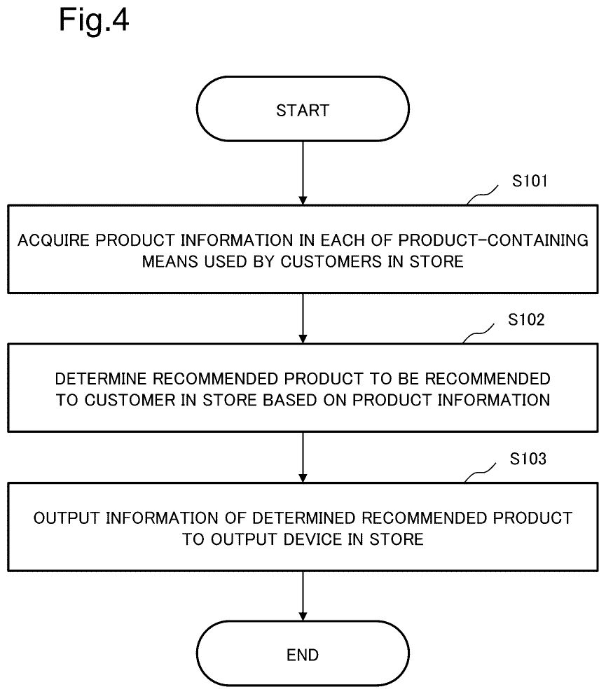

The CPU 501 operates the operating system to control the entire information providing device 100 according to the first example embodiment of the present invention. The CPU 501 reads a program and data from a recording medium 506 mounted on, for example, a drive device 507 to a memory. The CPU 501 functions as the acquiring unit 101, the determining unit 102, the outputting unit 103, and a part thereof in the first example embodiment, and executes processing or commands in the flowchart illustrated in FIG. 4 to be described later based on a program.

The recording medium 506 is, for example, an optical disk, a flexible disk, a magnetic optical disk, an external hard disk, a semiconductor memory, or the like. A semiconductor memory or the like which is a part of the recording medium is a non-volatile storage device, and records a program therein. The program may be downloaded from an external computer (not illustrated) connected to a communication network.

As described above, the first example embodiment illustrated in FIG. 1 is implemented by the computer hardware illustrated in FIG. 2. However, the means for implementing each unit included in the information providing device 100 of FIG. 1 is not limited to the configuration described above. The information providing device 100 may be implemented by one physically coupled device, or may be implemented by a system by connecting two or more physically separated devices in a wired or wireless manner.

The acquiring unit 101 is a means that acquires the product information in each of product-containing means used by customers in the store. The product-containing means is a container for storing a product to be purchased by a customer, and is, for example, a shopping basket or a shopping cart. The shopping cart may be a smart shopping cart equipped with a product scanning function. The shopping cart may be provided with a tablet terminal having a display. The product information in the present example embodiment is product information included in all the product-containing means used by the customer in the store.

The acquiring unit 101 reads an identification code attached to a product with a camera or a scanner, for example, and acquires product information in the product-containing means. In a case where a product includes a radio frequency identification (RFID) tag, the acquiring unit 101 may acquire the product information in the RFID tag by an RFID reading means. The acquiring unit 101 may acquire the product information by analyzing a product image acquired by a camera or the like provided at a position where the contents of the product-containing means are visible. The acquiring unit 101 may acquire the product information acquired by the customer from the product shelf by analyzing an image captured by a security camera in the store. When the product-containing means has a scan function, the acquiring unit 101 may acquire the product information scanned by the customer.

Next, the acquiring unit 101 counts the number of products in all the product-containing means used by the customers in the store for each product or for each category. In the present example embodiment, the category of the product may be a broad category such as a sales place such as vegetables, meat, confectionery, frozen food, fresh food, and seasoning. The product category may be classified into small categories such as potato chips and curry roux. The product category may be both a large classification and a small classification.

The determining unit 102 is a means that determines a recommended product to be recommended to the customers in the store based on the product information. For example, in a case where a predetermined number or more of the specific products or the products of the specific category are included in the product information, the determining unit 102 determines one of the products or the products of the category as the recommended products. The number of recommended products determined by the determining unit 102 may be one or more.

In a case where there are a plurality of recommended product candidates, the determining unit 102 may determine a recommended product to be recommended to customers in the store based on inventory information in the store. That is, in a case where a predetermined number or more of products are plural, or in a case where a product of a specific category is determined as a recommended product, the determining unit 102 may determine a product whose stock quantity of the store is a predetermined number or more from among the plurality of products or the products of the specific category as the recommended product.

The outputting unit 103 is a means that outputs information of the determined recommended product to an output device in the store. The outputting unit 103 outputs information of the recommended product to any output device in the store. The outputting unit 103 may output the information of the recommended product to all the output devices installed in the store. The outputting unit 103 may output the information of the recommended product to an output device installed within a predetermined distance from the display shelf of the recommended product, or may output the information of the recommended product in a case where there is a customer within a predetermined distance from the output device.

The outputting unit 103 may provide the information of the recommended product through a shopping application program downloaded to the terminal possessed by the customer or the tablet terminal provided in the shopping cart.

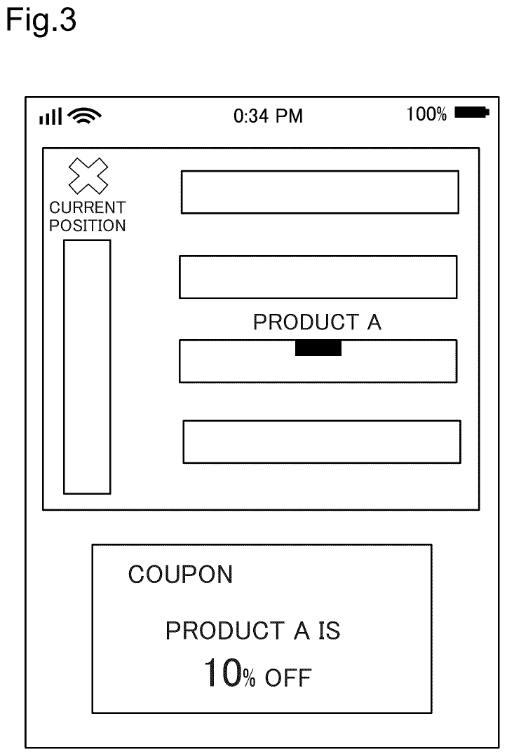

The outputting unit 103 outputs, for example, an area map indicating a display place of the recommended product, a coupon, price change information, or inventory replenishment information as the information of the recommended product. FIG. 3 is an example of a screen of information of a recommended product output by the outputting unit 103. In the example of FIG. 3, an area map indicating a display place of a recommended product and a coupon are output. The price change information is information indicating that the price of the recommended product has decreased. The inventory replenishment information is information indicating that the recommended product is replenished to the product shelf. However, the information output by the outputting unit 103 is not limited thereto as long as it is information related to the recommended product.

The outputting unit 103 may output information of the recommended product on a receipt issued after checkout of the product. A two-dimensional barcode for outputting the information of the recommended product may be attached to the product-containing means or the receipt. In this case, the outputting unit 103 displays the information of the recommended product associated with the two-dimensional barcode on the customer terminal with reading of the information of the two-dimensional barcode by the customer terminal as a trigger.

FIG. 4 is a flowchart illustrating an outline of an operation of the information providing device 100 according to the first example embodiment. The processing according to this flowchart may be executed based on program control by the processor described above. The processing according to this flowchart is performed at an arbitrary timing, and is performed, for example, at a timing of changing information of a recommended product to be output to an output device in a store.

FIG. 4 is a flowchart illustrating an operation of the information providing device 100 according to the first example embodiment. The acquiring unit 101 acquires the product information in each of product-containing means used by customers in the store (step S101). Next, the determining unit 102 determines a recommended product to be recommended to the customers in the store based on the product information (step S102). The outputting unit 103 outputs information of the determined recommended product to an output device in the store (step S103). As described above, the information providing device 100 ends the information providing processing.

As described above, in the information providing device 100 according to the first example embodiment, the determining unit 102 determines a recommended product to be recommended to the customers in the store based on the product information in each product-containing means used in the store, and outputs information of the recommended product determined by the outputting unit 103 to the output device in the store. As a result, for example, it is possible to provide another customer with the real-time hot-selling item information of the customer staying in the store. It is possible to provide the product information of a hot-selling item that the customer may purchase regardless of the situation of the customer's shopping.

### Modification of First Example Embodiment

Next, a modification of the first example embodiment of the present disclosure will be described in detail with reference to the drawings. Hereinafter, description of contents overlapping with the above description will be omitted to the extent that the description of the present example embodiment is not unclear.

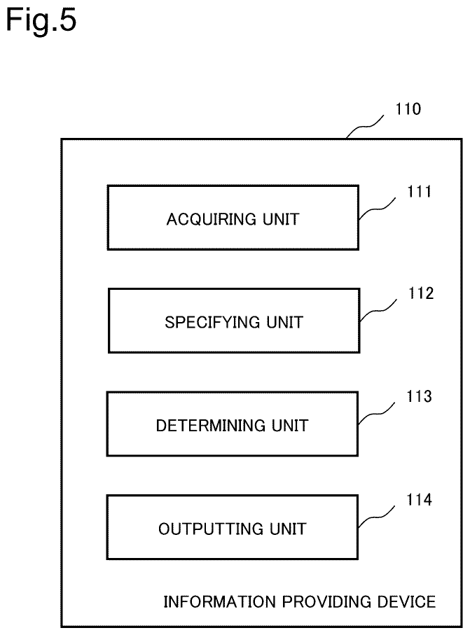

FIG. 5 is a block diagram illustrating a configuration example of an information providing device 110 according to a modification of the first example embodiment. Referring to FIG. 5, the information providing device 110 includes an acquiring unit 111, a specifying unit 112, a determining unit 113, and an outputting unit 114. In the present modification, the acquiring unit 111 acquires the product information in the product-containing means in the store as well as the position information of each product-containing means. In the present modification, the acquiring unit 111 uses the position information acquired from the customer terminal such as the tablet terminal provided in the shopping cart or the customer's own terminal as the position information of the product-containing means.

The acquiring unit 111 specifies the position information of the product-containing means based on the position information of the customer terminal. For example, the acquiring unit 111 may specify the position information of the product-containing means based on the position of the customer terminal specified by the radio field intensity by the wireless communication with the customer terminal using the near field communication by Bluetooth Low Energy (BLE) and the communication device arranged in the store. The acquiring unit 111 may specify the position information of each product-containing means by analyzing the background image of the product-containing means captured by the security camera in the store. The acquiring unit 111 associates the product information in the product-containing means with the position information of the product-containing means, and outputs the information to the specifying unit 112.

The specifying unit 112 is a means that specifies a sales place in which a predetermined number or more of product-containing means exist based on the position information. The specifying unit 112 counts the number of product-containing means existing for each sales place, and specifies a sales place in which a predetermined number or more of product-containing means exist. The specifying unit 112 may specify a sales place in which a predetermined ratio or more of the product-containing means exist in the product-containing means of the entire store.

The determining unit 113 determines a recommended product to be recommended to the customers in the store based on the product information in the product-containing means existing in the specified sales place. The determining unit 113 counts the number of products in all the product-containing means used by the customers in the specified sales place for each product or for each category. For example, in a case where a predetermined number or more of the specific products or the products of the specific category are included in the product information, the determining unit 102 determines one of the products or the products of the category as the recommended products. The determining unit 113 may determine, as the recommended product, a product displayed in a sales place where the product-containing means exists.

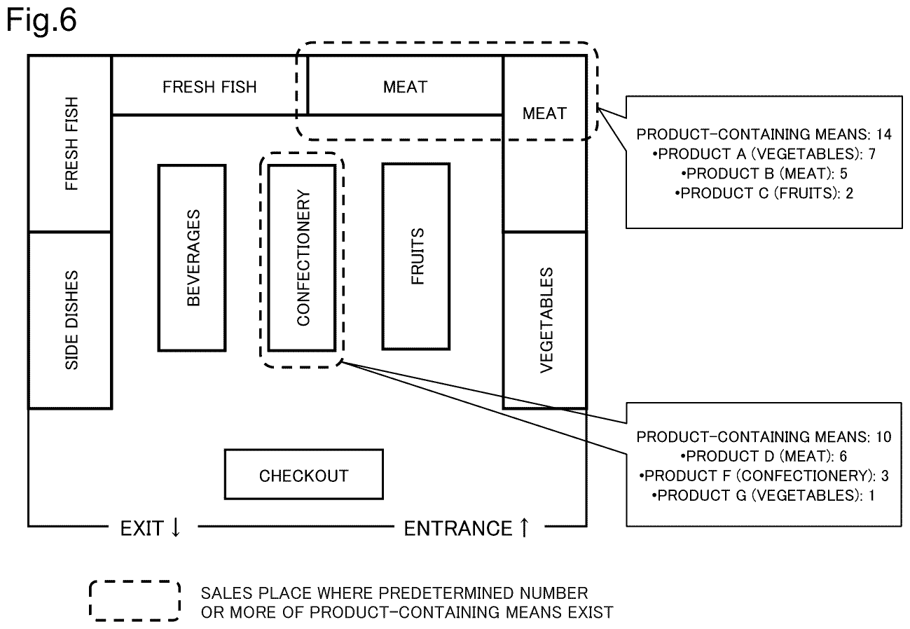

Here, a method of determining a recommended product by the determining unit 113 will be described. FIG. 6 is a diagram for explaining a method of determining a recommended product. In the example of FIG. 6, the sales place in the store is divided into vegetables, fruits, meat, confectionery, fresh fish, beverages, and side dishes. However, the way of dividing the sales place is not limited thereto. In the example of FIG. 6, meat and confectionery sales places are specified as sales places in which a predetermined number or more (for example, 10 or more) of product-containing means exist. In the meat sales place, there are fourteen product-containing means, and in these product-containing means, there are seven, five, and two products A to C in total. In the sales place of confectionery, there are ten product-containing means, and in the product-containing means, there are six, three, and one products D to F in total. In FIG. 6, information of the sales place in which the product is displayed is illustrated in parentheses next to each product name. The specifying unit 112 may determine either the product A or the product D, which is the largest in the product-containing means in the meat and confectionery sales places, as the recommended product, or may determine both the product A and the product D as the recommended products.

The determining unit 113 may determine, as the recommended product, a product displayed in a sales place where the product-containing means exists, among the products in the product-containing means. In the example of FIG. 6, among the products in the product-containing means existing in the meat sales place, the product B is displayed in the meat sales place. Among the products in the product-containing means existing in the sales place of confectionery, the product F is displayed in the sales place of confectionery. Therefore, the determining unit 113 may determine either the product B or the product F as the recommended product, or may determine both the product B and the product F as the recommended products. The determining unit 113 outputs the recommended product thus determined to the outputting unit 114. A method of outputting the recommended product by the outputting unit 114 is similar to that of the first example embodiment. In the present modification, the outputting unit 114 may further output the position of the sales place or the like in which the product-containing means exists in the store and the product information in the product-containing means to the output device on the store side as illustrated in FIG. 6. The outputting unit 114 may display the position and the number of each product-containing means existing in the store on a heat map. The output device on the store side is, for example, a display device in the backyard of the store or a display of a terminal carried by an employee.

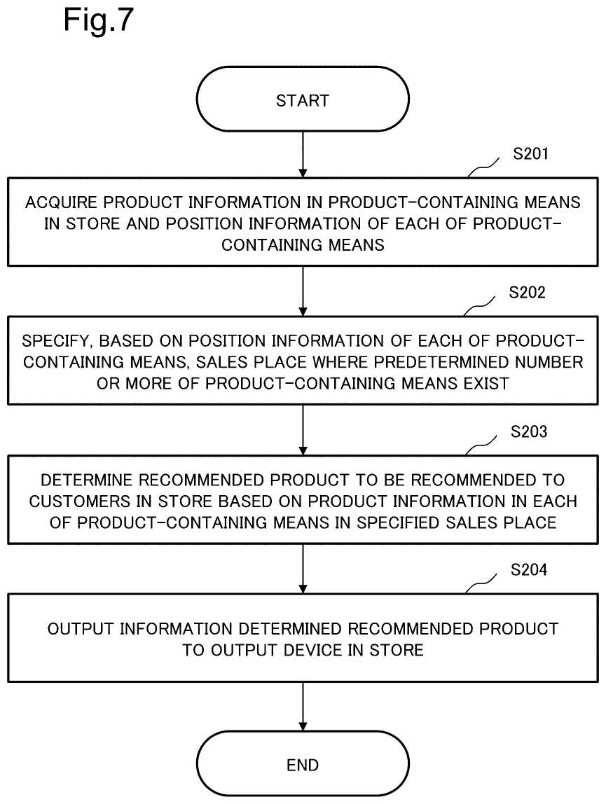

FIG. 7 is a flowchart illustrating an operation of the information providing device 110 in a modification of the first example embodiment. The acquiring unit 111 acquires the product information in the product-containing means in the store and the position information of each product-containing means (step S201). Next, the specifying unit 112 specifies a sales place in which a predetermined or more product-containing means exists based on the position information of each product-containing means (step S202). The determining unit 113 determines a recommended product to be recommended to the customers in the store based on the product information in each product-containing means existing in the specified sales place (step S203). The outputting unit 114 outputs information of the determined recommended product to an output device in the store (step S204). As described above, the information providing device 110 ends the information providing processing.

As described above, in the information providing device 110 according to the modification of the first example embodiment, the determining unit 113 determines a recommended product to be recommended to the customers in the store based on the product information in the product-containing means in the sales place in which there are a predetermined number or more of product-containing means, and the outputting unit 114 outputs information of the determined recommended product to the output device in the store. As a result, for example, it is possible to provide the product information of the hot-selling item in the sales place in which many customers are interested to another customer.

### Second Example Embodiment

Next, a second example embodiment of the present disclosure will be described in detail with reference to the drawings. Hereinafter, description of contents overlapping with the above description will be omitted to the extent that the description of the present example embodiment is not unclear.

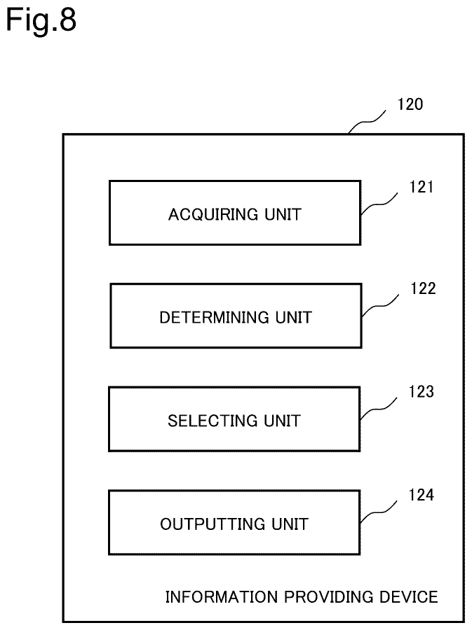

FIG. 8 is a block diagram illustrating a configuration of an information providing device 120 according to a second example embodiment. Similarly to the computer device illustrated in FIG. 2, the information providing device 120 can be achieved not only by hardware but also by a computer device or software based on program control.

The information providing device 120 includes a selecting unit 123 in addition to the components of the information providing device 100 in the first example embodiment. Referring to FIG. 8, the information providing device 120 includes an acquiring unit 121, a determining unit 122, a selecting unit 123, and an outputting unit 124.

The acquiring unit 121 acquires the product information in the product-containing means in the store as well as the position information of each product-containing means. In the present modification, the acquiring unit 121 uses the position information acquired from the customer terminal such as the tablet terminal provided in the shopping cart or the customer's own terminal as the position information of the product-containing means. The acquiring unit 121 outputs the product information in the product-containing means and the position information of each product-containing means to the determining unit 122. The determining unit 122 determines information of a recommended product similarly to the determining unit 102 in the first example embodiment.

The selecting unit 123 is a means that selects a customer to which information of the determined recommended product is to be provided. For example, the selecting unit 123 selects a customer based on the product information in the product-containing means of each customer. For example, the selecting unit 123 may select a customer whose product-containing means does not include the recommended product.

The selecting unit 123 may analyze a product that is likely to be purchased by each customer based on the product information in the product-containing means of each customer, and select a customer whose product matches or is associated with the recommended product. Hereinafter, a method of analyzing a product that each customer is likely to purchase by the selecting unit 123 will be described, but the analysis method is not limited thereto.

The selecting unit 123 analyzes a purchase trend of each customer from, for example, the product information in the product-containing means of each customer as a product that each customer is likely to purchase. In a case where a predetermined ratio or more of low-price products are included in the product information of an arbitrary customer, the selecting unit 123 analyzes that the purchase trend of the customer is price-oriented. On the other hand, in a case where a predetermined ratio or more of high-quality products are included in the product information of an arbitrary customer, the selecting unit 123 analyzes that the purchase trend of the customer is quality-oriented. The selecting unit 123 may select a customer matching the purchase trend analyzed by the recommended product.

For example, the selecting unit 123 estimates a dish to be made from product information of each customer as a product that each customer is likely to purchase, and analyzes other ingredients and the like necessary for making the dish. The selecting unit 123 may select a customer including the recommended product among the analyzed ingredients.

In the present example embodiment, in a case where an application program for shopping in a store is installed in advance in the customer terminal, the selecting unit 123 may select a customer to which the information of the recommended product is to be provided based on attribute information such as gender and age of the user, and customer information such as a purchase history and a traffic line analysis result, which are registered in association with a customer identification (ID) of the application program for shopping. In this case, the information of the recommended product can be provided to the customer who is more likely to purchase the recommended product.

The outputting unit 124 outputs information of the recommended product to an output device within a predetermined distance from the product-containing means of the selected customer.

The outputting unit 124 may output the information of the recommended product on an application program installed in the customer terminal used by the selected customer. In this case, it is assumed that an application program for shopping in a store is installed in advance in the customer terminal, and the product information in the product-containing means is scanned by the customer and held on the application program.

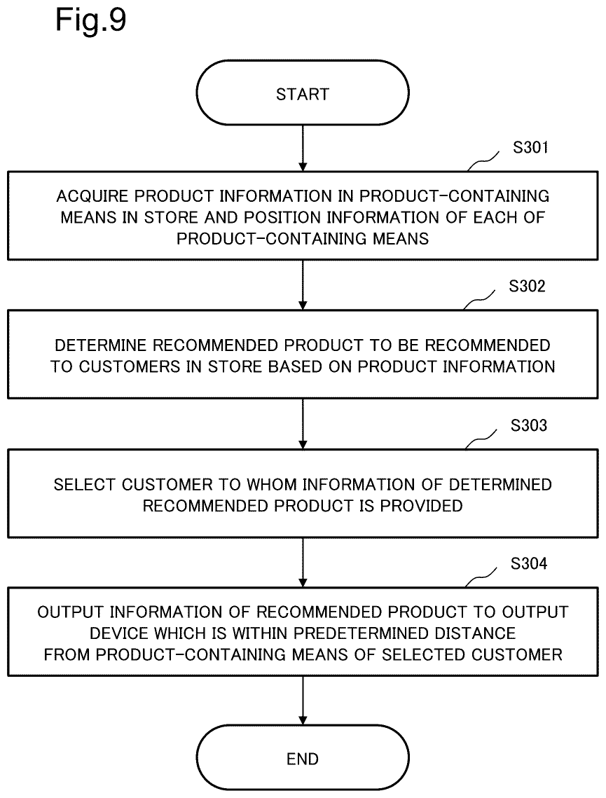

FIG. 9 is a flowchart illustrating an operation of the information providing device 120 according to the second example embodiment. The acquiring unit 121 acquires the product information in the product-containing means in the store and the position information of each product-containing means (step S301). Next, the determining unit 122 determines a recommended product to be recommended to the customers in the store based on the product information (step S302). Next, the selecting unit 123 selects a customer to which the information of the determined recommended product is to be provided (step S303). The outputting unit 124 outputs information of the recommended product to an output device within a predetermined distance from the product-containing means of the selected customer (step S304). As described above, the information providing device 120 ends the information providing processing.

As described above, in the information providing device 120 according to the second example embodiment, the selecting unit 123 selects, based on the product information in the product-containing means, a customer to which the information of the determined recommended product is to be provided.. In this case, the information of the recommended product can be provided to a customer who is more likely to purchase the recommended product.

### Modification of Second Example Embodiment

Next, a modification of the second example embodiment of the present disclosure will be described in detail with reference to the drawings. Hereinafter, description of contents overlapping with the above description will be omitted to the extent that the description of the present example embodiment is not unclear.

In the second example embodiment, the selecting unit 123 selects, based on the product information in the product-containing means, a customer to which information of a recommended product is to be provided. In a modification of the second example embodiment, another method in which the selecting unit 123 selects a customer will be described.

The selecting unit 123 may select a customer based on the storage status in the product-containing means. More specifically, the selecting unit 123 selects a customer using a product-containing means having a gap for storing the recommended product in the product-containing means of each customer. The selecting unit 123 may determine whether there is a gap by analyzing an image which indicates a storage status in the product-containing means and is captured by a camera provided at a position where the contents of the product-containing means are visible, a security camera provided in a store, or the like.

The selecting unit 123 may calculate the gap based on the information regarding the dimension of the product in the product-containing means. Specifically, for example, the selecting unit 123 acquires dimensional information of a product associated with product information in the product-containing means of the customer from the product database. The product database is stored in the storage device 505, for example. The dimensional information indicates the size of a product, and typically includes three pieces of information of the width, depth, and height of the product. The selecting unit 123 calculates the total volume of all the products in the product-containing means. Then, based on the size of the gap obtained by subtracting the calculated total volume from the volume of the product-containing means, the selecting unit 123 selects the customer using the product-containing means in a case where there is a gap for storing the recommended product or in a case where there is a certain margin or more of the gap.

The selecting unit 123 may select a customer based on the weight of all products in the product-containing means. Specifically, the selecting unit 123 selects a customer whose weight of all products in the product-containing means is equal to or less than a predetermined reference weight. Also in this case, the selecting unit 123 acquires the weight information of the product associated with the product information from the product database. The weight reference used at this time may be different depending on the weight of the recommended product or the attribute of the customer. As described above, in a case where the customer is selected based on the storage status in the product-containing means, the recommended product can be put into the product-containing means, or the information of the recommended product can be provided to the customer who can easily put the recommended product into the product-containing means.

As another modification of the method of selecting a customer by the selecting unit 123, the selecting unit 123 may select a customer heading in the display direction of the recommended product. The selecting unit 123 acquires information regarding the display place of the recommended product from the product database. The selecting unit 123 may estimate the direction toward which the customer is heading by a known method using a gyro sensor or an angular velocity sensor provided in the customer terminal, or may acquire time-series position information of the customer and estimate the direction toward which the customer is heading. The direction toward which the customer is heading may be estimated by analyzing a moving image captured by a security camera in the store. In this case, it is possible to provide information of recommended products by narrowing down to customers who pass before the display of the recommended product.

While the present disclosure has been particularly shown and described with reference to each of example embodiments, the present disclosure is not limited to the above example embodiments. The configurations and details of the present disclosure may include example embodiments to which various changes that can be grasped by those of ordinary skill in the art without departing from the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above-described example embodiments may be described as the following supplementary notes, but are not limited to the following supplementary notes.

### Supplementary Note 1

An information providing device including:
an acquiring means that acquires product information in each of product-containing means being used by customers in a store;
a determining means that determines a recommended product to recommend to customers in the store based on the product information; and
an outputting means that outputs information of the determined recommended product to an output device in the store.

### Supplementary Note 2

The information providing device according to Supplementary Note 1, in which
the acquiring means further acquires position information of each of the product-containing means,
the information providing device further comprises a specifying means that specifies, based on the position information, a sales place in which a predetermined number or more of product-containing means exist, and
the determining means determines a recommended product to be recommended to customers in the store based on product information in each product-containing means existing in the specified sales place.

### Supplementary Note 3

The information providing device according to Supplementary Note 1 or 2, in which the determining means determines a recommended product to be recommended to customers in the store based on inventory information in the store in a case where there is a plurality of recommended product candidates.

### Supplementary Note 4

The information providing device according to any one of Supplementary Notes 1 to 3, further including:
a selecting means that selects a customer to which information of the determined recommended product is to be provided, in which
the outputting means outputs information of the recommended product to an output device within a predetermined distance from a product-containing means of the selected customer.

### Supplementary Note 5

The information providing device according to Supplementary Note 4, in which the selecting means selects the customer based on product information in a product-containing means of each customer.

### Supplementary Note 6

The information providing device according to Supplementary Note 5, in which the selecting means analyzes a product that is likely to be purchased by each customer based on product information of each of the customer, and selects the customer based on a result of the analysis.

### Supplementary Note 7

The information providing device according to Supplementary Note 5 or 6, in which the selecting means selects a customer whose product-containing means does not include the recommended product.

### Supplementary Note 8

The information providing device according to Supplementary Note 4, in which the selecting means selects a customer based on a storage status in a product-containing means of each of the customer.

### Supplementary Note 9

The information providing device according to Supplementary Note 4, in which the selecting means selects a customer facing a display direction of the recommended product.

### Supplementary Note 10

The information providing device according to any one of Supplementary Notes 1 to 9, in which the outputting means outputs an area map, a coupon, price change information, or inventory replenishment information related to a recommended product as information of the recommended product.

### Supplementary Note 11

An information providing method causing a computer to execute:
acquiring product information in each of product-containing means being used by customers in a store;
determining a recommended product to recommend to customers in the store based on the product information; and
outputting information of the determined recommended product to an output device in the store.

### Supplementary Note 12

A recording medium having stored therein a program causing a computer to execute:
acquiring product information in each of product-containing means being used by customers in a store;
determining a recommended product to recommend to customers in the store based on the product information; and
outputting information of the determined recommended product to an output device in the store.

### Reference Signs List

100, 110, 120 information providing device
101, 111, 121 acquiring unit
102, 113, 122 determining unit
103, 114, 124 outputting unit
112 specifying unit
123 selecting unit
500 computer device
501 CPU
502 ROM
503 RAM
504 program
505 storage device
506 recording medium
507 drive device
508 communication interface
509 input/output interface
510 bus

What is claimed is:

1. An information providing device comprising:
one or more memories storing instructions; and
one or more processors configured to execute the instructions to:
acquire product information in each of product-containing means being used by customers in a store;
determine a recommended product to recommend to customers in the store based on the product information; and
output information of the determined recommended product to an output device in the store.

2. The information providing device according to claim 1, wherein the one or more processors configured to execute the instructions to:
further acquire position information of each of the product-containing means,
specify, based on the position information, a sales place in which a predetermined number or more of product-containing means exist, and
determine a recommended product to be recommended to customers in the store based on product information in each product-containing means existing in the specified sales place.

3. The information providing device according to claim 1, wherein the one or more processors configured to execute the instructions to:
determine a recommended product to be recommended to customers in the store based on inventory information in the store in a case where there is a plurality of recommended product candidates.

4. The information providing device according to claim 1, wherein the one or more processors configured to execute the instructions to:
select a customer to which the information of the determined recommended product is to be provided, and
output information of the recommended product to an output device within a predetermined distance from a product-containing means of the selected customer.

5. The information providing device according to claim 4, wherein the one or more processors configured to execute the instructions to:
select the customer based on product information in a product-containing means of each customer.

6. The information providing device according to claim 5, wherein the one or more processors configured to execute the instructions to:
analyze a product that is likely to be purchased by each customer based on product information of each of the customer, and selects the customer based on a result of the analysis.

7. The information providing device according to claim 5, wherein the one or more processors configured to execute the instructions to:
select, as the customer to which the information of the determined recommended product is to be provided, a customer whose the product-containing means does not include the recommended product.

8. The information providing device according to claim 4, wherein the one or more processors configured to execute the instructions to:
select the customer based on a storage status in a product-containing means of each of the customer.

9. The information providing device according to claim 4, wherein the one or more processors configured to execute the instructions to:
select, as the customer to which the information of the determined recommended product is to be provided, a customer facing a display direction of the recommended product.

10. The information providing device according to claim 1, wherein the one or more processors configured to execute the instructions to:
output an area map, a coupon, price change information, or inventory replenishment information related to a recommended product as information of the recommended product.

11. An information providing method causing a computer to execute:
acquiring product information in each of product-containing means being used by customers in a store;
determining a recommended product to recommend to customers in the store based on the product information; and
outputting information of the determined recommended product to an output device in the store.

12. A non-transitory recording medium having stored therein a program causing a computer to execute:
acquiring product information in each of product-containing means being used by customers in a store;
determining a recommended product to recommend to customers in the store based on the product information; and
outputting information of the determined recommended product to an output device in the store.
